(19) United States
(12) Patent Application Publication
(10) Pub. No.: US 2016/0347006 A1
(43) Pub. Date: Dec. 1, 2016

(54) IMAGE DATA GENERATOR AND THREE-DIMENSIONAL PRINTING APPARATUS INCLUDING THE SAME

(71) Applicant: Roland DG Corporation, Hamamatsu-shi (JP)

(72) Inventor: Kouichi KOBAYASHI, Hamamatsu-shi (JP)

(21) Appl. No.: 15/164,991

(22) Filed: May 26, 2016

(30) Foreign Application Priority Data
May 29, 2015 (JP) 2015-109687

(51) Int. Cl. B29C 67/00

(52) U.S. Cl. CPC B29C 67/0088; B29C 67/0085; B29C 67/0059; B33Y 30/00

(57) ABSTRACT

An image data generator includes a first coloring processor that colors each of portions of a first surface area and each of portions of a second surface area with a first color and a second color, respectively, a second coloring processor that colors some of portions of a first boundary area with the first color and color the other portions with the second color, or colors one or more of the portions of the first boundary area with a mixed color that is a mixture of the first and second colors, and a third coloring processor that colors some of portions of a second boundary area with the second color and color the other portions with the first color, or colors one or more of the portions of the second boundary area with the mixed color that is a mixture of the first and second colors.

### CROSS-REFERENCE TO RELATED APPLICATIONS

This application claims priority to Patent Application No. 2015-109687 filed in Japan on May 29, 2015, the entire contents of which are hereby incorporated by reference.

### BACKGROUND OF THE INVENTION

1. Field of the Invention

The present invention generally relates to image data generators and three-dimensional printing apparatuses, and more particularly relates to an image data generator that generates image data of a three-dimensional object and a three-dimensional printing apparatus including the image data generator.

2. Description of the Related Art

A three-dimensional printing apparatus known in the art sequentially stacks layers each having a predetermined cross-sectional shape, thus printing a three-dimensional object.

Printing methods performed by three-dimensional printing apparatuses include inkjet printing, fused deposition modeling, stereolithography, plaster-based 3D printing, and selective laser sintering. In printing a “figure”, for example, plaster-based 3D printing is preferably performed because plaster-based 3D printing facilitates coloring of the figure. As used herein, the term “figure” includes not only action figures, character figures, figurines, and dolls, but also scale models and miniature toys. Plaster-based 3D printing involves forming a plaster powder layer and spraying droplets onto the layer so as to solidify the layer, which results in a cross-sectional body. A plurality of such cross-sectional bodies are stacked, thus eventually printing a three-dimensional object. For example, JP 2003-145630 A discloses a three-dimensional printing apparatus that prints a three-dimensional object using plaster powder and colors the surface of the three-dimensional object. This three-dimensional printing apparatus includes an inkjet head provided with nozzles to discharge ink droplets and UV curable resin.

Supposing that a three-dimensional object includes a first surface and a second surface adjacent to the first surface, with a boundary between the first and second surfaces, the first surface may be colored with a first color, and the second surface may be colored with a second color different from the first color. In this case, however, coloring the three-dimensional object in accordance with image data makes it difficult to color a boundary region straddling the boundary between the first and second surfaces (i.e., a region including an area of the first surface close to the boundary and an area of the second surface close to the boundary) such that the first and second surfaces are respectively distinctly colored with the first and second colors. This is because an inkjet head moves in a direction intersecting the boundary in coloring the boundary region. This may unfavorably cause ink dots formed by ink discharged from the inkjet head to straddle the boundary.

Specifically, when the inkjet head moves to the boundary region from one end of the first surface, the boundary region is colored with the first color. This means that not only the area of the first surface close to the boundary but also the area of the second surface close to the boundary is colored with the first color. When the inkjet head moves to the boundary region from one end of the second surface, the boundary region is colored with the second color. This means that not only the area of the second surface close to the boundary but also the area of the first surface close to the boundary is colored with the second color.

Unlike what is printed on a flat paper medium, the three-dimensional object provides a different visual effect depending on the angle at which the three-dimensional object is viewed. For example, suppose that the second surface is viewed at an angle at which the first surface is hidden. In this case, if a portion of the second surface that should normally be colored with the second color (i.e., the area of the second surface close to the boundary) is actually colored with the first color, this portion of the second surface gives a user an unnatural visual impression. Such improper coloring unfortunately results in noticeable visual differences between image data which is presented on a computer and in which the boundary region is distinctly colored with different colors and the three-dimensional object whose boundary region is actually colored using the inkjet head.

### SUMMARY OF THE INVENTION

Accordingly, preferred embodiments of the present invention provide a three-dimensional object image data generator that reduces visual differences between image data presented on a computer and an actual three-dimensional object, and a three-dimensional printing apparatus including such an image data generator.

An image data generator according to a preferred embodiment of the present invention generates image data of a three-dimensional object including a plurality of layers. The three-dimensional object includes a first surface, and a second surface adjacent to the first surface, with a boundary between the first surface and the second surface. The first surface includes a first surface area, and a first boundary area between the first surface area and the boundary. The first surface area and the first boundary area each include a plurality of portions each associated with a corresponding one of the layers of the three-dimensional object. The second surface includes a second surface area, and a second boundary area between the second surface area and the boundary. The second surface area and the second boundary area each include a plurality of portions each associated with a corresponding one of the layers of the three-dimensional object. The image data generator includes a first coloring processor, a second coloring processor, and a third coloring processor. The first coloring processor is configured or programmed to color each of the portions of the first surface area with a first color, and color each of the portions of the second surface area with a second color different from the first color. The second coloring processor is configured or programmed to color some of the portions of the first boundary area with the first color and color the other portions of the first boundary area with the second color, or color one or more of the portions of the first boundary area with a mixed color that is a mixture of the first color and the second color. The third coloring processor is configured or programmed to color some of the portions of the second boundary area with the second color and color the other portions of the second boundary area with the first color, or color one or more of the portions of the second boundary area with the mixed color that is a mixture of the first color and the second color.

The image data generator according to this preferred embodiment colors the first boundary area and the second boundary area, which are included in a boundary region straddling the boundary between the first and second surfaces, in the above-described manner. This visually blurs the boundary region in the image data of the three-dimensional object. Consequently, the image data generator according to this preferred embodiment reduces visual differences between the image data presented on a computer and the three-dimensional object whose boundary region is actually colored.

Thus, various preferred embodiments of the present invention provide a three-dimensional object image data generator that reduces visual differences between image data presented on a computer and an actual three-dimensional object, and a three-dimensional printing apparatus including such an image data generator.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic diagram illustrating a three-dimensional printing apparatus and an image data generator according to a preferred embodiment of the present invention.

FIG. 2 is a perspective view of a colored three-dimensional object according to a preferred embodiment of the present invention.

FIGS. 3A and 3B each illustrate an exemplary three-dimensional object coloring method according to a preferred embodiment of the present invention.

FIG. 4 is a diagram schematically illustrating texture mapping according to a preferred embodiment of the present invention.

FIG. 5 is a plan view of a three-dimensional object according to a preferred embodiment of the present invention.

### DETAILED DESCRIPTION OF THE PREFERRED EMBODIMENTS

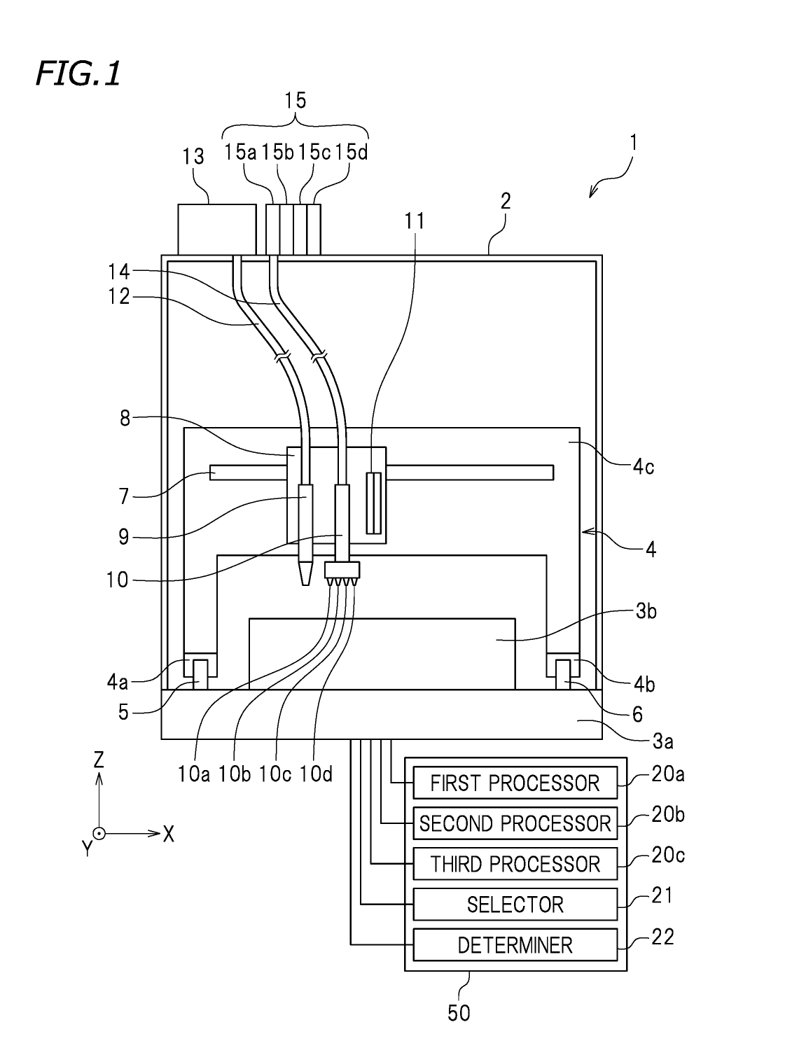

Preferred embodiments of the present invention will be described below with reference to the drawings. As illustrated in FIG. 1, axes perpendicular to each other are defined as an “X axis”, a “Y axis”, and a “Z axis”. A three-dimensional printing apparatus 1 is placed on a plane defined by the X and Y axes. As used herein, the terms “rightward” and “leftward” respectively refer to the direction toward the right of FIG. 1 and the direction toward the left of FIG. 1. As used herein, the terms “forward” and “rearward” respectively refer to the direction toward the viewer of FIG. 1 and the direction away from the viewer of FIG. 1. Note that these directions are defined merely for the sake of convenience and are not intended to limit in any way how the three-dimensional printing apparatus 1 may be installed.

As illustrated in FIG. 1, the three-dimensional printing apparatus 1 preferably has a box shape. Specifically, the three-dimensional printing apparatus 1 preferably includes a housing box 2; and a base 3a connected to the lower end of the housing box 2. Inside the housing box 2 is a table 3b provided on the base 3a. The table 3b has a horizontal upper surface. A three-dimensional object (not illustrated) is printed on the upper surface of the table 3b. A portal guide rail 4 straddles the table 3b. The guide rail 4 preferably includes a leg 4a provided leftward of the table 3b; a leg 4b provided rightward of the table 3b; and a connection 4c extending in the right-left direction and connecting the leg 4a and the leg 4b. The connection 4c is provided with a guide rail 7 extending in the right-left direction.

A carriage 8 is provided above the table 3b. The carriage 8 holds a printing nozzle 9, an ink head 10, and an applicator 11. The printing nozzle 9 discharges resin material. The resin material discharged from the printing nozzle 9 forms a yet-to-be-cured resin layer having a predetermined cross-sectional shape. The applicator 11 applies ultraviolet rays to cure the resin material. The yet-to-be-cured resin layer is cured by being exposed to the ultraviolet rays applied from the applicator 11. This results in a cured resin layer. Sequentially stacking such resin layers provides a multilayered three-dimensional object. The resin layers are stacked at a pitch of about 0.1 mm, for example. The resin layers may be stacked at any pitch. The ink head 10 preferably includes four discharge nozzles to discharge ink, i.e., a discharge nozzle 10a, a discharge nozzle 10b, a discharge nozzle 10c, and a discharge nozzle 10d, for example. Using the discharge nozzles 10a, 10b, 10c, and 10d, the three-dimensional object is colored for each of the resin layers.

The carriage 8 slides on the guide rail 7. This enables the printing nozzle 9, the ink head 10, and the applicator 11 to move in the right-left direction. The upper left portion of the base 3a is provided with a guide rail 5 extending in the front-rear direction. The upper right portion of the base 3a is provided with a guide rail 6 extending in the front-rear direction. The leg 4a slides on the guide rail 5. The leg 4b slides on the guide rail 6. Thus, the printing nozzle 9, the ink head 10, and the applicator 11 are movable in the front-rear direction. A driving device (not illustrated) enables the printing nozzle 9, the ink head 10, and the applicator 11 to be movable also in the up-down direction.

The housing box 2 is externally provided with a printing material tank 13 storing UV curable resin serving as printing material; and an ink tank assembly 15 storing ink. The ink tank assembly 15 preferably includes four ink tanks, i.e., an ink tank 15a, an ink tank 15b, an ink tank 15c, and an ink tank 15d. The ink tank 15a stores yellow (Y) ink, the ink tank 15b stores magenta (M) ink, the ink tank 15c stores cyan (C) ink, and the ink tank 15d stores black (K) ink. These inks are in liquid form. The printing nozzle 9 is connected to the printing material tank 13 through a tube 12. The printing material stored in the printing material tank 13 is supplied to the printing nozzle 9 through the tube 12. The ink head 10 is connected to the ink tank assembly 15 through a tube assembly 14. Specifically, the tube assembly 14 includes first to fourth thin tubes (not illustrated) inserted therethrough. The discharge nozzle 10a is connected to the ink tank 15a through the first thin tube. This allows the ink in the ink tank 15a to be supplied to the discharge nozzle 10a. The discharge nozzle 10b is connected to the ink tank 15b through the second thin tube. This allows the ink in the ink tank 15b to be supplied to the discharge nozzle 10b. The discharge nozzle 10c is connected to the ink tank 15c through the third thin tube. This allows the ink in the ink tank 15c to be supplied to the discharge nozzle 10c. The discharge nozzle 10d is connected to the ink tank 15d through the fourth thin tube. This allows the ink in the ink tank 15d to be supplied to the discharge nozzle 10d.

As illustrated in FIG. 1, the image data generator 50 according to this preferred embodiment preferably is an external device connected to the three-dimensional printing apparatus 1. Alternatively, the image data generator 50 may be incorporated into the three-dimensional printing apparatus 1. The image data generator 50 may be a computer that includes a central processing unit (CPU), a read-only memory (ROM), and a random-access memory (RAM). The image data generator 50 preferably includes a first processor 20a, a second processor 20b, a third processor 20c, a selector 21, and a determiner 22. The CPU executes program(s) stored in advance in the image data generator 50, thus implementing the functions of the first processor 20a, the second processor 20b, the third processor 20c, the selector 21, and the determiner 22. The first processor 20a is an example of a first coloring processor, the second processor 20b is an example of a second coloring processor, the third processor 20c is an example of a third coloring processor, the selector 21 is an example of a selecting processor, and the determiner 22 is an example of a determining processor. The first processor 20a (first coloring processor), the second processor 20b (second coloring processor), the third processor 20c (third coloring processor), the selector 21 (selecting processor), and the determiner 22 (determining processor) may physically be the same processor, or may be different processors.

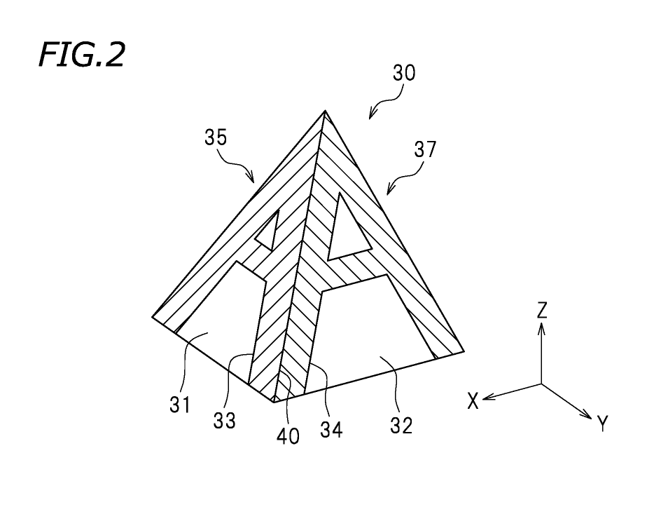

The image data generator 50 generates image data of a three-dimensional object. Specifically, the image data generator 50 generates image data of resin layers of a three-dimensional object. The image data of each resin layer of a three-dimensional object will hereinafter be referred to as “sliced data”. As illustrated in FIG. 2, the image data generator 50 generates image data of a three-dimensional object 30 having a triangular pyramidal shape, for example. More specifically, the image data generator 50 generates image data of the three-dimensional object 30 including a first surface 31, and a second surface 32 adjacent to the first surface 31, with a boundary 40 between the first surface 31 and the second surface 32. The first surface 31 and the second surface 32 intersect each other. Three-dimensional object image data includes shape data indicative of the shape of a three-dimensional object, and coloring data indicative of color(s) for the shape. A text image 35 representing “A” is formed on the first surface 31. A text image 37 representing “A” is formed on the second surface 32. The first processor 20a colors the text image 35 on the first surface 31 with a first color (e.g., red), and colors the text image 37 on the second surface 32 with a second color (e.g., blue) different from the first color. The first processor 20a, the second processor 20b, and the third processor 20c perform coloring for each piece of sliced data.

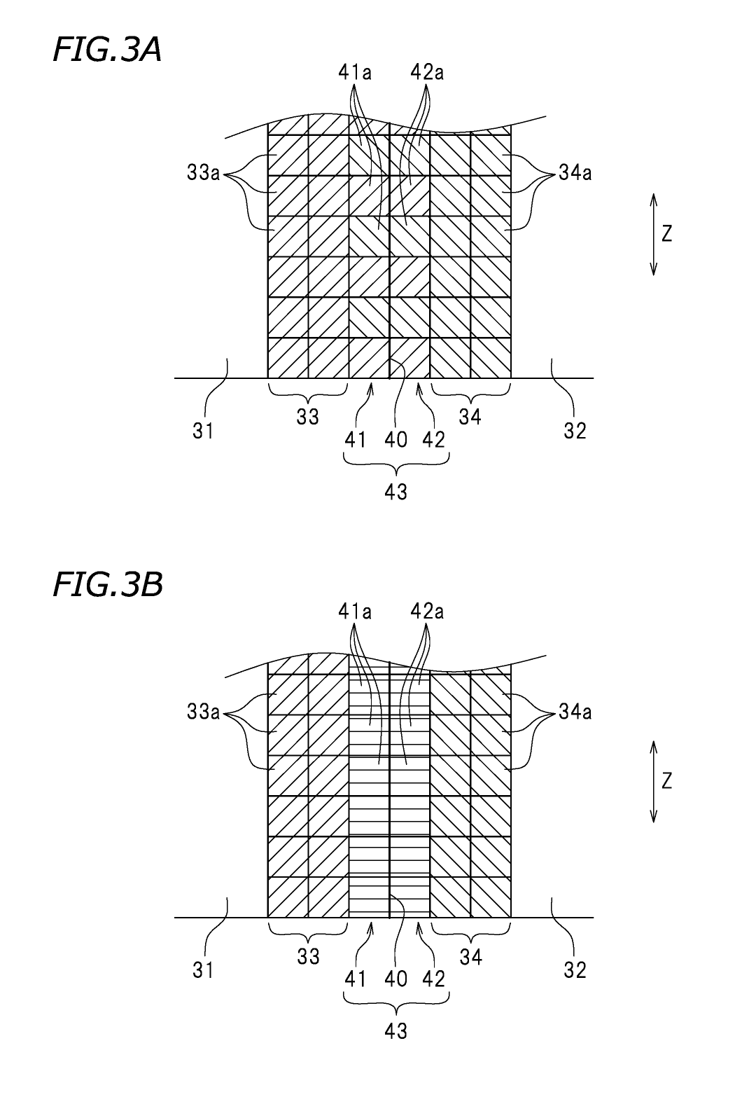

A three-dimensional object represented by image data generated by the image data generator 50 will be described below. The three-dimensional object represented by the image data generated by the image data generator 50 preferably includes a plurality of layers. As illustrated in FIGS. 3A and 3B, the first surface 31 of the three-dimensional object preferably includes a first surface area 33, and a first boundary area 41 between the first surface area 33 and the boundary 40. The second surface 32 of the three-dimensional object preferably includes a second surface area 34, and a second boundary area 42 between the second surface area 34 and the boundary 40. The first surface area 33 is adjacent to the first boundary area 41. The second surface area 34 is adjacent to the second boundary area 42. The first surface area 33 is larger than the first boundary area 41. The second surface area 34 is larger than the second boundary area 42. A combination of the first boundary area 41, the boundary 40, and the second boundary area 42 will hereinafter be referred to as a “boundary region 43”. The first surface area 33 preferably includes a plurality of portions 33a aligned in the up-down direction Z. The second surface area 34 preferably includes a plurality of portions 34a aligned in the up-down direction Z. The first boundary area 41 preferably includes a plurality of portions 41a aligned in the up-down direction Z. The second boundary area 42 preferably includes a plurality of portions 42a aligned in the up-down direction Z. The portions 33a, 41a, 42a, and 34a aligned in the horizontal direction are elements of the data of each layer of the three-dimensional object 30, i.e., the sliced data of the three-dimensional object 30.

In FIGS. 3A and 3B, a region hatched with lines slanting down from right to left is colored with the first color, and a region hatched with lines slanting down from left to right is colored with the second color. As illustrated in FIG. 3A, the second processor 20b colors some of the portions 41a of the first boundary area 41 with the first color (e.g., red), and colors the other portions 41a with the second color (e.g., blue). The third processor 20c colors some of the portions 42a of the second boundary area 42 with the first color, and colors the other portions 42a with the second color. For example, the second processor 20b colors the portions 41a of the first boundary area 41 such that odd-numbered ones of the portions 41a and even-numbered ones of the portions 41a are colored with different colors, and the third processor 20c colors the portions 42a of the second boundary area 42 such that odd-numbered ones of the portions 42a and even-numbered ones of the portions 42a are colored with different colors. In one example, the second processor 20b colors the odd-numbered ones of the portions 41a of the first boundary area 41 with the first color and colors the even-numbered ones of the portions 41a of the first boundary area 41 with the second color, and the third processor 20c colors the odd-numbered ones of the portions 42a of the second boundary area 42 with the first color and colors the even-numbered ones of the portions 42a of the second boundary area 42 with the second color. This causes the portions of the boundary region 43 to be colored with the first color and the second color alternately in the up-down direction Z. Thus, the boundary region 43 is colored in a visually smooth manner. In other words, the boundary region 43 is colored in a visually blurred manner. The first processor 20a, the second processor 20b, and the third processor 20c detect the boundary 40 from the shape data.

The boundary region 43 may be colored as follows. As illustrated in FIG. 3B, the second processor 20b may color the portions 41a of the first boundary area 41 with a mixed color that is a mixture of the first color and the second color. The mixed color is violet, for example. As illustrated in FIG. 3B, the third processor 20c may color the portions 42a of the second boundary area 42 with the mixed color. In FIG. 3B, a region hatched with horizontal lines is colored with the mixed color. For example, the second processor 20b and the third processor 20c each perform coloring using, as the mixed color, an intermediate color between the first color and the second color. In this case also, the boundary region 43 is colored in a visually smooth manner. In other words, the boundary region 43 is colored in a visually blurred manner. As used herein, the term “intermediate color” refers to a color having the following attributes: 1) an intermediate hue between the hue of the first color and the hue of the second color; 2) an intermediate chroma between the chroma of the first color and the chroma of the second color; and 3) an intermediate lightness between the lightness of the first color and the lightness of the second color. The term “intermediate color” may refer to a color having at least one of the attributes 1) to 3). As used herein, the term “mixed color” refers to a color generated by mixing at least two of the three primary colors, i.e., red, green, and blue, but does not refer to the three primary colors themselves.

In response to an operation performed by a user, for example, the selector 21 makes a selection as described below. In one example, the user operates a button displayed on a touch panel (not illustrated) of the three-dimensional printing apparatus 1, thus transmitting a signal from the touch panel to the selector 21. In response to this signal, the selector 21 makes a selection as described below. The second processor 20b colors the portions 41a of the first boundary area 41 with a first mixed color in accordance with an instruction from the selector 21. The third processor 20c colors the portions 42a of the second boundary area 42 with a second mixed color in accordance with an instruction from the selector 21.

The first mixed color is a mixed color closer in hue to the first color than to the intermediate color. The second mixed color is a mixed color closer in hue to the second color than to the intermediate color. For example, the expression “mixed color closer in hue to the first color than to the intermediate color” refers to a color that is closer in hue to the first color than to the intermediate color in the hue circle. The expression “mixed color closer in hue to the second color than to the intermediate color” refers to a color that is closer in hue to the second color than to the intermediate color in the hue circle. In one example, assuming that the first color is red and the second color is blue, the first mixed color is very reddish violet, and the second mixed color is very bluish violet.

The user is allowed to use the selector 21 so as to select colors for the first boundary area 41 and the second boundary area 42. The user may select the intermediate color or the first mixed color for the first boundary area 41. Selecting the first mixed color for the first boundary area 41 enables blurring of the boundary while making the color of the first boundary area 41 close to the first color. The user may also select the intermediate color or the second mixed color for the second boundary area 42. Selecting the second mixed color for the second boundary area 42 enables blurring of the boundary while making the color of the second boundary area 42 close to the second color.

The user is allowed to use the selector 21 so as to select the first surface 31 or the second surface 32 as the surface whose boundary area is to be colored with the first mixed color or the second mixed color. For example, when the selector 21 selects the first surface 31 in response to an operation performed by the user, the second processor 20b colors some or all of the portions 41a of the first boundary area 41 with the first mixed color. In this case, the third processor 20c may color some or all of the portions 42a of the second boundary area 42 with the first mixed color or the intermediate color. When the selector 21 selects the second surface 32 in response to an operation performed by the user, the third processor 20c colors some or all of the portions 42a of the second boundary area 42 with the second mixed color. In this case, the second processor 20b may color some or all of the portions 41a of the first boundary area 41 with the second mixed color or the intermediate color.

In this preferred embodiment, the image data generator 50 is capable of generating image data of a three-dimensional object that is a figure, such as a character figure or a toy car, for example. A character figure, for example, has a predetermined orientation and thus includes a front surface and lateral surfaces. For a doll figure, a surface of the doll figure including its face is a front surface, and surfaces of the doll figure including right and left arms are lateral surfaces. For such a doll figure, the image of the front surface is more important than the images of the lateral surfaces. A toy car, for example, also has a predetermined orientation and thus includes a peripheral surface and a bottom surface. The peripheral surface includes a front surface, a right lateral surface, a left lateral surface, and a rear surface. As used herein, the term “peripheral surface” refers to the peripheral surface of a three-dimensional object which is continuous with the perimeter of the bottom surface. For such a toy car, the image of the peripheral surface is more important than the image of the bottom surface.

In generating image data of, for example, a character figure, the image data generator 50 defines the front surface of the character figure as the first surface 31, and defines the lateral surface of the character figure as the second surface 32. In generating image data of, for example, a toy car, the image data generator 50 defines the peripheral surface of the toy car as the first surface 31, and defines the bottom surface of the toy car as the second surface 32. In one example, the second processor 20b colors the portions 41a of the first boundary area 41 with the first mixed color, and the third processor 20c colors the portions 42a of the second boundary area 42 with the first mixed color. This reduces visual differences between the image data presented on the computer and the actual three-dimensional object for the more important surface.

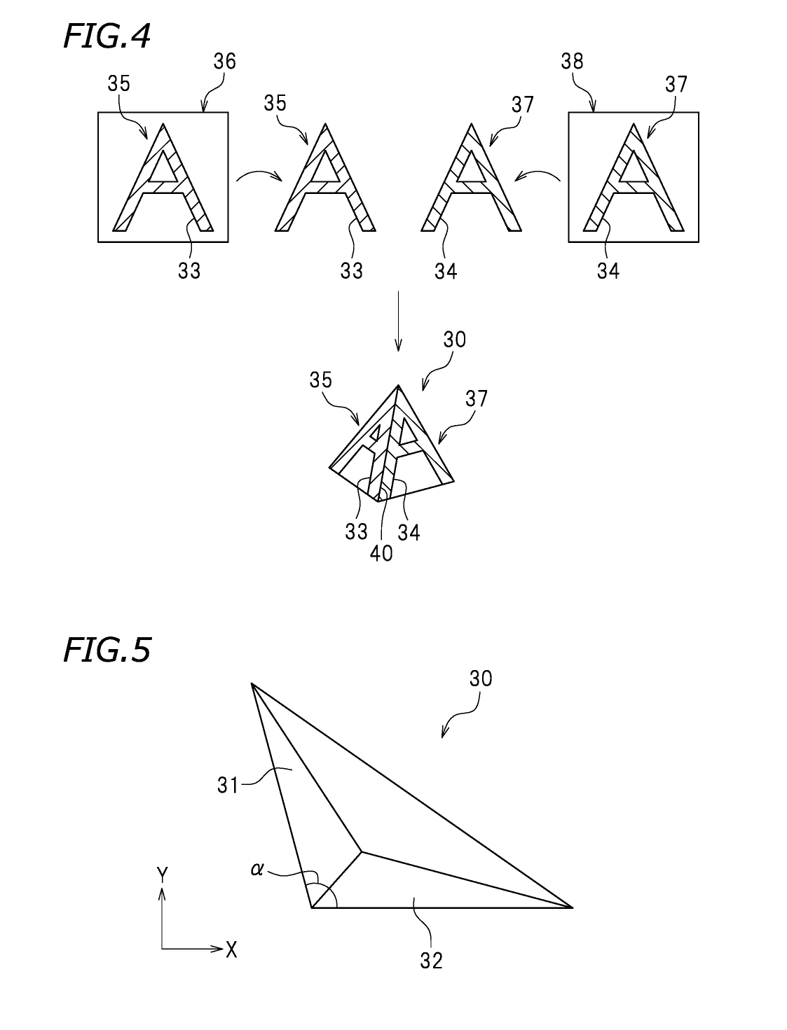

The text image 35 and the text image 37 may be colored separately or independently. For example, as illustrated in FIG. 4, the text image 35 is colored in a full image 36, and the text image 37 is colored in a full image 38 different from the full image 36. Then, from the full image 36 including the text image 35, only the text image 35 is extracted, and from the full image 38 including the text image 37, only the text image 37 is extracted. The text image 35 and the text image 37, which have been extracted, are pasted on the shape data, thus providing image data of the three-dimensional object 30 that has been colored. In this case, this pasting process is performed with reference to the boundary 40. Such a pasting process is generally referred to as “texture mapping”.

Whether the boundary region 43 should be colored in the above-described manner may be decided on the basis of the positional relationship between the first surface 31 and the second surface 32. For example, as illustrated in FIG. 5, suppose that an interior angle α formed between the first surface 31 and the second surface 32 of the three-dimensional object 30 is about 90 degrees or more, for example. In this case, viewing the first surface 31 in a direction perpendicular to the first surface 31 allows the user to visually identify not only the first boundary area 41 of the first surface 31, which is included in the boundary region 43, but also the second boundary area 42 of the second surface 32, which is included in the boundary region 43. Similarly, viewing the second surface 32 in a direction perpendicular to the second surface 32 allows the user to visually identify not only the second boundary area 42 of the second surface 32, which is included in the boundary region 43, but also the first boundary area 41 of the first surface 31, which is included in the boundary region 43. When the interior angle α is about 180 degrees or more, the boundary region 43, including the first and second boundary areas 41 and 42 of the first and second surfaces 31 and 32, is inconspicuous. When the interior angle α formed between the first surface 31 and the second surface 32 is about 90 degrees or more but less than about 180 degrees, the boundary region 43 is conspicuous, which means that the above-described coloring effect is more beneficial. For example, the determiner 22 determines whether the interior angle α formed between the first surface 31 and the second surface 32 of the three-dimensional object 30 is about 90 degrees or more but less than about 180 degrees. Following a determination that the interior angle α is about 90 degrees or more but less than about 180 degrees, the second processor 20b and the third processor 20c color the boundary region 43 (see FIGS. 3A and 3B) in the above-described manner. Following a determination that the interior angle α is less than about 90 degrees or is about 180 degrees or more, the second processor 20b and the third processor 20c do not color the boundary region 43 in the above-described manner.

The image data generator 50 according to this preferred embodiment generates image data of the three-dimensional object 30 in which the first boundary area 41 and the second boundary area 42, included in the boundary region 43, are colored in the above-described manner. This enables the boundary region 43 to be visually blurred in the image data of the three-dimensional object 30. Consequently, the image data generator 50 according to this preferred embodiment reduces visual differences between the image data of the three-dimensional object 30 presented on the computer and the three-dimensional object 30 whose boundary region 43 is actually colored using the ink head 10.

In one example of this preferred embodiment, the image data generator 50 colors the first boundary area 41 and the second boundary area 42 using, as the mixed color, the intermediate color between the first color and the second color. This effectively visually blurs the first boundary area 41 and the second boundary area 42 in the image data. Thus, the image data generator 50 according to this preferred embodiment further reduces visual differences between the image data presented on the computer and the actual three-dimensional object.

In another example of this preferred embodiment, the portions 41a colored with the first color and the portions 41a colored with the second color are alternately arranged in the first boundary area 41, and the portions 42a colored with the first color and the portions 42a colored with the second color are alternately arranged in the second boundary area 42. This effectively visually blurs the first boundary area 41 and the second boundary area 42 in the image data. Thus, the image data generator 50 according to this preferred embodiment further reduces visual differences between the image data presented on the computer and the actual three-dimensional object.

In still another example of this preferred embodiment, the portions 41a of the first boundary area 41 are colored with the first mixed color, and the portions 42a of the second boundary area 42 are colored with the second mixed color. This brings the hue of the first boundary area 41 closer to the hue of the first color than to the hue of the intermediate color, and brings the hue of the second boundary area 42 closer to the hue of the second color than to the hue of the intermediate color. Consequently, the boundary between the color of the first boundary area 41 and the first color is less visible, and the boundary between the color of the second boundary area 42 and the second color is less visible.

According to this preferred embodiment, the selector 21 may select the first mixed color or the second mixed color for coloring in accordance with the type of the three-dimensional object 30. For example, for a three-dimensional object, such as a figure whose front surface is often seen, the image data generator 50 may perform coloring such that the first boundary area 41, which is included in the front surface of the figure, is colored with the first mixed color, but the second boundary area 42, which is included in the lateral surface of the figure, is not colored with the second mixed color.

For example, for a three-dimensional object, such as a character figure whose front surface is often seen, the image data generator 50 according to this preferred embodiment may perform coloring such that the first boundary area, which is included in the front surface of the figure, is colored with the first mixed color, but the second boundary area, which is included in the lateral surface of the figure, is not colored with the second mixed color. For example, for a three-dimensional object, such as a toy car that is often put on a stand, the image data generator 50 may perform coloring such that the first boundary area, which is included in the peripheral surface of the toy car, is colored with the first mixed color, but the second boundary area, which is included in the bottom surface of the toy car, is not colored with the second mixed color.

When the interior angle α formed between the first surface 31 and the second surface 32 of the three-dimensional object 30 is determined to be about 90 degrees or more but less than about 180 degrees in a plan view, the image data generator 50 according to this preferred embodiment colors the boundary region 43 with the first color and the second color alternately or with the mixed color, which is a mixture of the first and second colors, in the above-described manner. When the interior angle α is determined to be less than about 90 degrees or to be about 180 degrees or more, the image data generator 50 according to this preferred embodiment neither colors the boundary region 43 with the first color and the second color alternately nor colors the boundary region 43 with the mixed color, which is a mixture of the first and second colors. Thus, the image data generator 50 performs neither of these coloring processes for the boundary region 43 of the three-dimensional object 30 whose second surface 32 is invisible when the three-dimensional object 30 is viewed in a direction perpendicular to the first surface 31. In this case, the first surface 31 is entirely colored with the first color, and the second surface 32 is entirely colored with the second color, so that the processing time is shorter than when the boundary region 43 is colored with the first color and the second color alternately or with the mixed color in the above-described manner.

The second processor 20b and the third processor 20c according to this preferred embodiment detect the boundary 40 from the shape data of the three-dimensional object 30. This facilitates detection of the boundary 40 between the first surface 31 and the second surface 32.

Although the boundary region 43 is subjected to the above-described coloring so as to visually blur the boundary region 43 in this preferred embodiment, the present invention is not limited to this method. For example, a moving average filter, a Gaussian filter, or a median filter may be used to smooth and blur the boundary region 43. A moving average filter averages the colors of elements neighboring a target element. A Gaussian filter is used in calculating a weighted average by giving greater weights to elements neighboring a target element as their distance to the target element decreases and giving smaller weights to the neighboring elements as their distance to the target element increases. A median filter replaces the color of a target element with the median color of elements neighboring the target element.

In this preferred embodiment, the odd-numbered ones of the portions 41a and 42a in the boundary region 43 are colored with the first color with which the text image 35 is colored, and the even-numbered ones of the portions 41a and 42a in the boundary region 43 are colored with the second color with which the text image 37 is colored. The present invention, however, is not limited to such coloring. Alternatively, the odd-numbered ones of the portions 41a and 42a in the boundary region 43 may be colored with the second color, and the even-numbered ones of the portions 41a and 42a in the boundary region 43 may be colored with the first color.

In this preferred embodiment, all of the portions 41a of the first boundary area 41 and all of the portions 42a of the second boundary area 42 preferably are colored in the above-described manner. The present invention, however, is not limited to such coloring. For example, some of the portions 41a of the first boundary area 41 and some of the portions 42a of the second boundary area 42 may be colored.

In this preferred embodiment, the boundary region 43 is colored in the above-described manner when the interior angle α formed between the first surface 31 and the second surface 32 of the three-dimensional object 30 is about 90 degrees or more but less than about 180 degrees. The present invention, however, is not limited to such coloring. In one example, the boundary region 43 may be colored in the above-described manner when the interior angle α is less than about 90 degrees. In another example, the boundary region 43 may be colored in the above-described manner when the interior angle α is about 180 degrees or more.

The three-dimensional printing apparatus 1 according to this preferred embodiment performs inkjet printing. The present invention, however, is not limited to three-dimensional printing apparatuses that perform inkjet printing. The present invention is also applicable to three-dimensional printing apparatuses that perform other printing methods, such as fused deposition modeling, stereolithography, plaster-based 3D printing, and selective laser sintering.

The terms and expressions that have been employed are used as terms of description and not of limitation, and there is no intention, in the use of such terms and expressions, of excluding any equivalents of the features shown and described or portions thereof, but it is recognized that various modifications are possible within the scope of the invention claimed. While the present invention may be embodied in many different forms, a number of preferred embodiments are described herein with the understanding that the present disclosure is to be considered as providing examples of the principles of the present invention and that such examples are not intended to limit the present invention to preferred embodiments described herein and/or illustrated herein. Hence, the present invention is not limited to the preferred embodiments described herein. The present invention includes any and all preferred embodiments including equivalent elements, modifications, omissions, combinations, adaptations and/or alterations as would be appreciated by those skilled in the art on the basis of the present disclosure. The limitations in the claims are to be interpreted broadly based on the language included in the claims and not limited to examples described in the present specification or during the prosecution of the application.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An image data generator that generates image data of a three-dimensional object including a plurality of layers;
the three-dimensional object including:
a first surface; and
a second surface adjacent to the first surface, with a boundary between the first surface and the second surface,
the first surface including:
a first surface area; and
a first boundary area between the first surface area and the boundary;
the first surface area and the first boundary area each including a plurality of portions each associated with a corresponding one of the layers of the three-dimensional object;
the second surface including:
a second surface area; and
a second boundary area between the second surface area and the boundary;
the second surface area and the second boundary area each including a plurality of portions each associated with a corresponding one of the layers of the three-dimensional object;
the image data generator comprising:
a first coloring processor configured or programmed to color each of the portions of the first surface area with a first color, and color each of the portions of the second surface area with a second color different from the first color;
a second coloring processor configured or programmed to color some of the portions of the first boundary area with the first color and color the other portions of the first boundary area with the second color, or color one or more of the portions of the first boundary area with a mixed color that is a mixture of the first color and the second color; and
a third coloring processor configured or programmed to color some of the portions of the second boundary area with the second color and color the other portions of the second boundary area with the first color, or color one or more of the portions of the second boundary area with the mixed color that is a mixture of the first color and the second color.

2. The image data generator according to claim 1, wherein
the second coloring processor is configured or programmed to color the plurality of portions of the first boundary area with the first color and the second color alternately; and
the third coloring processor is configured or programmed to color the plurality of portions of the second boundary area with the first color and the second color alternately.

3. The image data generator according to claim 1, wherein the mixed color is an intermediate color between the first color and the second color.

4. The image data generator according to claim 1, wherein the mixed color includes:
a first mixed color closer in hue to the first color than to an intermediate color between the first color and the second color; and
a second mixed color closer in hue to the second color than to the intermediate color;
the second coloring processor is configured or programmed to color some or all of the plurality of portions of the first boundary area with the first mixed color; and
the third coloring processor is configured or programmed to color some or all of the plurality of portions of the second boundary area with the second mixed color.

5. The image data generator according to claim 1, wherein the mixed color includes:
a first mixed color closer in hue to the first color than to an intermediate color between the first color and the second color; and
a second mixed color closer in hue to the second color than to the intermediate color;
the image data generator further comprises a selecting processor configured or programmed to select one of the first surface and the second surface;
the second coloring processor is configured or programmed to, when the first surface is selected by the selecting processor, color some or all of the plurality of portions of the first boundary area with the first mixed color; and
the third coloring processor is configured or programmed to, when the second surface is selected by the selecting processor, color some or all of the plurality of portions of the second boundary area with the second mixed color.

6. The image data generator according to claim 1, wherein the mixed color includes:
a first mixed color closer in hue to the first color than to an intermediate color between the first color and the second color; and
a second mixed color closer in hue to the second color than to the intermediate color;
the first surface includes a front surface of the three-dimensional object;
the second surface includes a lateral surface of the three-dimensional object; and
the second coloring processor is configured or programmed to color some or all of the plurality of portions of the first boundary area with the first mixed color.

7. The image data generator according to claim 1, wherein the mixed color includes:
a first mixed color closer in hue to the first color than to an intermediate color between the first color and the second color; and
a second mixed color closer in hue to the second color than to the intermediate color;
the first surface includes a peripheral surface of the three-dimensional object;
the second surface includes a bottom surface of the three-dimensional object; and
the second coloring processor is configured or programmed to color some or all of the plurality of portions of the first boundary area with the first mixed color.

8. The image data generator according to claim 1, wherein
the image data of the three-dimensional object includes shape data indicative of a shape of the three-dimensional object; and
the second coloring processor and the third coloring processor are configured or programmed to detect the boundary from the shape data.

9. An image data generator that generates image data of a three-dimensional object including a plurality of layers;
the three-dimensional object including:
a first surface; and
a second surface adjacent to the first surface, with a boundary between the first surface and the second surface;
the first surface including:
a first surface area; and
a first boundary area between the first surface area and the boundary;
the first surface area and the first boundary area each including a plurality of portions each associated with a corresponding one of the layers of the three-dimensional object;
the second surface including:
a second surface area; and
a second boundary area between the second surface area and the boundary;
the second surface area and the second boundary area each including a plurality of portions each associated with a corresponding one of the layers of the three-dimensional object;
the image data generator comprising:
a determining processor configured or programmed to determine whether an interior angle formed between the first surface and the second surface is about 90 degrees or more but less than about 180 degrees;
a first coloring processor configured or programmed to color each of the portions of the first surface area with a first color, and color each of the portions of the second surface area with a second color different from the first color;
a second coloring processor configured or programmed to, when the interior angle is determined to be about 90 degrees or more but less than about 180 degrees by the determining processor, color some of the portions of the first boundary area with the first color and color the other portions of the first boundary area with the second color, or color one or more of the portions of the first boundary area with a mixed color that is a mixture of the first color and the second color, and configured or programmed to, when the interior angle is determined to be less than about 90 degrees or to be about 180 degrees or more by the determining processor, color each of the portions of the first boundary area with the first color; and
a third coloring processor configured or programmed to, when the interior angle is determined to be about 90 degrees or more but less than about 180 degrees by the determining processor, color some of the portions of the second boundary area with the second color and color the other portions of the second boundary area with the first color, or color one or more of the portions of the second boundary area with the mixed color that is a mixture of the first color and the second color, and configured or programmed to, when the interior angle is determined to be less than about 90 degrees or to be about 180 degrees or more by the determining processor, color each of the portions of the second boundary area with the second color.

10. A three-dimensional printing apparatus comprising:
the image data generator according to claim 1; and
a printing device that prints a three-dimensional object using image data generated by the image data generator, the printing device including an ink head to discharge ink.

11. A three-dimensional printing apparatus comprising:
the image data generator according to claim 9; and
a printing device that prints a three-dimensional object using image data generated by the image data generator, the printing device including an ink head to discharge ink.
